(19) United States
(12) Patent Application Publication
(10) Pub. No.: US 2026/0222116 A1
(43) Pub. Date: Jul. 30, 2026

(54) DETERMINING RETRY ERROR CODES FROM AN ACQUISITION COMPLETION PROCESSOR

(71) Applicant: Walmart Apollo, LLC, Bentonville, AR (US)

(72) Inventors: Shri Sai Sadhana Natarajan, San Jose, CA (US); Ranjan Alankar Raju, Dublin, CA (US); Arunesh Joshi, Newark, CA (US); Chetan V. Sukthanker, Pleasanton, CA (US); Keertimaan Tenneti, Pleasanton, CA (US)

(21) Appl. No.: 19/040,229

(22) Filed: Jan. 29, 2025

(51) Int. Cl. H04L 1/08

(52) U.S. Cl. CPC H04L 1/08

(57) ABSTRACT

There are provided systems and methods for communicating with transaction processors and handling error codes received from them. A system may include: database(s) including records with acquisition completion methods; a processing resource; and a machine readable medium storing instructions. The processing resource may: access a record; retrieve an acquisition completion method; transmit a first communication including a first electronic acquisition completion attempt with the first acquisition completion method to an acquisition completion processor; receive an electronic communication from the acquisition completion processor including a decline indication and including an error code; determine that the error code matches one of a first set of error codes that are terminal error codes or matches one of a second set of error codes that are retry error codes. The processing resource updates the record based on receiving a terminal error code and retries the communication based on receiving a retry error code.

### TECHNICAL FIELD

This disclosure relates generally to communications with transaction processors, and more particularly, to communications returning error codes.

### BACKGROUND

In ecommerce and other settings, payment methods are frequently used to complete transactions. Some of these payment methods may be declined by payment processors for a variety of reasons, such as, for example, they may be invalid, expired, or fraudulent. Further, many of these payment methods may be stored for possible use in recurring and future transactions involving merchants and other certain entities where they may be repeatedly declined. It would be desirable to develop a mechanism to periodically filter out these bad payment methods before processing, which might otherwise result in inflated decline rates and eroded trust in merchants involved in the declined transactions.

### BRIEF DESCRIPTION OF THE DRAWINGS

Disclosed herein are embodiments of systems, apparatuses and methods involving communications with transaction processors returning error codes. This description includes drawings, wherein:

FIG. 1 depicts an example system for communicating with a payment processor and handling error codes received from the payment processor;

FIG. 2 depicts an example system for communicating with a payment processor and handling error codes received from the payment processor;

FIG. 3 depicts an example system for communicating with a payment processor and handling error codes received from the payment processor;

FIG. 4 is a flow diagram depicting an example method for communicating with a payment processor and handling error codes received from the payment processor;

FIG. 5 is a flow diagram depicting an example method for handling retry error codes received from the payment processor;

FIG. 6 is a flow diagram depicting an example method for communicating with a payment processor and handling error codes received from the payment processor;

FIG. 7 is a flow diagram depicting an example method of handling terminal error codes received from a payment processor;

FIG. 8 is a flow diagram depicting an example method of handling retry error codes received from a payment processor;

FIG. 9 is a block diagram depicting a machine readable medium with example instructions for communicating with a payment processor and handling error codes received from the payment processor;

FIG. 10 is a block diagram depicting a machine readable medium with example instructions for handling terminal error codes received from a payment processor; and

FIG. 11 is a block diagram depicting a machine readable medium with example instructions for handling retry error codes received from a payment processor.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “one form,” “some forms,” “an implementation”, “some implementations”, “some applications”, or similar language means that a particular feature, structure, or characteristic described in connection with the embodiment is included in but is not limited to at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

In one aspect, and without limitation, this disclosure addresses issues relating to payment methods, such as, for example, payment cards, that are declined by payment processors for various reasons, such as invalidity, expiration, or fraud. Despite these payment cards being declined, they may be stored in accounts and may continue to be used in subsequent transactions involving merchants. These payment methods may remain in the merchant's system as a viable candidate for future payment attempts. Without a mechanism to filter these declined cards before processing, unnecessary calls to payment processors inflate decline rates and erode trust in the merchant involved in those transactions. By preventing these declined cards from being included in future transactions, the number of declined transactions may be reduced. In turn, this reduced number may enhance the merchant's credibility and improve the merchant's overall payment acceptance rates by sending a higher proportion of successful transactions to the payment processors.

In one aspect, and without limitation, this disclosure uses error codes that are generated by payment processors when declining transactions and communicated to the merchant. Some of these error codes indicate that the payment method will likely never be accepted in the future. For these terminal error codes, the payment method may be flagged by the merchant for non-use in any future transaction. Some of these error codes indicate that the payment method was declined for certain temporary reasons but may be accepted in the future. For these retry error codes, a subsequent transaction is attempted with the same payment method to see if the payment method will be accepted at that later time. These transactions to check payment methods may be attempted periodically, such as, for example, when renewing a membership subscription with the merchant.

This disclosure uses the example of payments, payment methods, payment attempts, payment processors, etc. Although the disclosure uses this language involving payment terms, however, it should be understood that these terms can more generically be referred to in acquisition completion terms, e.g., where an item or service is intended to be acquired and this acquisition is to be completed. This disclosure is broadly directed to any of various types of transactions that involve some form of acquisition completion. For example, in some embodiments, one or more of: a payment may be more generically referred to as an acquisition completion; a payment method may be more generically referred to as an acquisition completion method; a payment attempt may be more generically referred to as an acquisition completion attempt; a payment processor may be more generically referred to as an acquisition completion processor; a payment decline indication may be more generically referred to as an acquisition completion decline indication; and a payment authorization indication may be more generically referred to as an acquisition completion authorization indication.

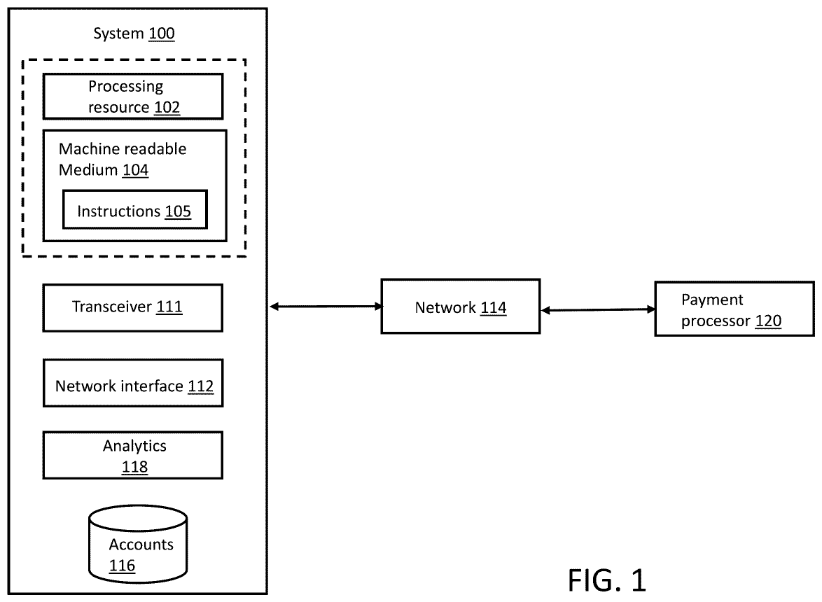

Referring now to the figures, FIG. 1 depicts an example system 100 that communicates with a payment processor 120 and that uses error codes received from unsuccessful payment attempts. The system 100 includes a processing resource 102 that may include a microcontroller, a microprocessor, central processing unit core(s), an application-specific integrated circuit (ASIC), a field programmable gate array (FPGA), etc. The system 100 includes a machine readable medium 104 that may be non-transitory and include random access memory (RAM), read-only memory (ROM), electrically erasable programmable read-only memory (EEPROM), flash memory, a hard disk drive, etc. The processing resource 102 may execute instructions 105 (i.e., programming or software code) stored on machine readable medium 104 to perform functions of the system 100. Additionally, or alternatively, the processing resource 102 may include electronic circuitry for performing the instructions and functionality described herein.

In that regard, the processing resource 102 may be configured to execute and perform certain operations. In this context, the term processing resource 102 refers broadly to any microcontroller, computer, or processor-based device with processor, memory, and programmable input/output peripherals. As shown in FIG. 1, the processing resource 102 may be coupled to a communication transceiver 111 and a network interface 112, which, in turn, may be coupled to wireless network(s) 114. The network interface 112 may enable the processing resource 102 to communicate with other elements (both internal and external to the system 100). The network interface 112 can communicatively couple the processing resource 102 to the wireless network 114 and whatever other networks 114 may be appropriate for the circumstances.

The processing resource 102 may make use of cloud databases and/or operate in conjunction with a cloud computing platform. The processing resource 102 may be coupled to and/or communicate with one or more databases (such as an accounts database 116) and with an analytics group 118 that may evaluate the data. Also, in some forms, as shown in FIG. 1, the one or more databases constitute local storage accessible to the system 100, while in other forms, they may constitute remote storage accessible via the network(s) 114. While one processing resource 102 is shown, in some forms, the functionalities of the processing resource 102 may be implemented on a plurality of processor devices communicating on a network 114.

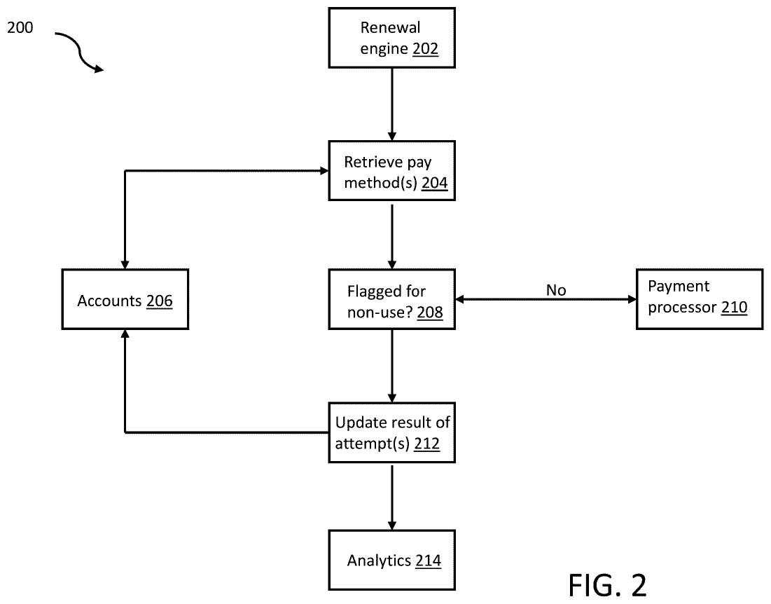

FIG. 2 shows a general example of a system 200 that uses error codes received from unsuccessful payment attempts to a payment processor. In this form, there is a renewal engine 202 that generally checks payment methods when a member subscription comes up for renewal. For example, this renewal check may be initiated on a billing day for member(s) when it is time to renew a membership subscription. It is generally contemplated that this time for renewal may be every month, every year, or some other discrete time period. It is further contemplated that the renewal engine 202 may include or be implemented using some or all of the components from FIG. 1, such as instructions 105 encoded to implement the functionality described below when executed on processing resource 102 or any other hardware device or electronic circuitry for implementing the functionality described below. Although in one form this disclosure may be used in the context of member renewals, this disclosure is not limited to renewals and may be used in other circumstances where payment methods are being checked or are being used.

In one form, the renewal engine 202 (via processing resource 102) may access record(s) and retrieve one or more payment methods 204, such as, for example, bank accounts or payment cards, from an accounts database 206. In some forms involving payment cards, the payment cards may be credit cards, debit cards, or other cards authorizing payment on behalf of a cardholder. As part of a membership, the record(s) may include an online wallet that may include several stored payment methods. In some forms, the accounts database 206 may be a database that holds records of accounts, such as, for example, accounts of a merchant and/or accounts corresponding to members of a certain group. The accounts database 206 may include multiple records with each record corresponding to a member and including one or more payment methods.

In one form, in the context of renewal, the renewal engine 202 may begin proceeding through the available payment methods (e.g., sequentially, simultaneously, etc.), attempting to capture a successful payment. It may be desired to obtain at least one successful payment capture to complete the renewal process. In the context of renewal, the process may be stopped when the first success or approval for authorization is received for one of the stored payment methods.

In one form, the renewal engine 202 initially determines whether a payment that is being checked may have already been flagged 208 (or associated with a specific key). In other words, the payment method may already be flagged for non-use based on invalidity, expiration, fraud, or some other reason, such as from a previous renewal check. If it has already been flagged, this payment method need not be checked again, and instead, another retrieved payment method 204 may be checked. In one form, the renewal engine 202 may check a previously-returned error code associated with that payment method from a previous renewal check and may skip that payment method if it matches certain known error codes, as addressed below.

Next, assuming that the payment method has not been flagged for non-use, the renewal engine 202 communicates with the payment processor 210. In one form, the renewal engine 202 formats a first electronic payment attempt to include the payment method and transmits a first communication including the first electronic payment attempt to the payment processor 210 via a communication network (such as network 114). The payment processor 210 may indicate that the payment attempt was successful without returning any error codes. In this form involving renewal of a membership, the renewal engine 202 may renew a membership subscription associated with a record upon successful transmission of the first communication without receiving an error code from the payment processor 210. In some forms, the renewal check for that account is then complete, and no further payment methods need be evaluated (although, in other forms, it may be desirable to check all payment methods). In the context of a renewal, the renewal engine 202 may transmit the first communication on a day when a membership subscription utilizing the payment method is considered for renewal.

However, if the payment attempt is declined, renewal engine 202 may receive an electronic communication from the payment processor 210 via the communication network 114 that includes a payment decline indication and that includes an error code. It has been determined that the error codes returned by the payment processor 210 provide data regarding reasons for the decline and/or an indication of the likelihood of future success using the payment method. This data may be used to avoid future declined transactions involving that payment method.

In one form, this returned error code may be compared against two sets of known error codes that may be stored in a database. The renewal engine 202 may determine that the error code matches one of a predetermined first set of one or more error codes in which these more error codes have been learned to be terminal error codes such that subsequent payment attempts will fail. In other words, the payment method will never be (or is unlikely to be) successful in future transactions. Alternatively, the renewal engine 202 may determine that the error code matches one of a predetermined second set of one or more error codes in which these error codes have been learned to be retry error codes such that subsequent payment attempts may be successful under one or more circumstances. For example, there may be insufficient funds in an account resulting in a declined payment, which may suggest retrying at a later time. The one or more circumstances under which they may be successful may depend on, and be specific to, the retry error code.

Next, the renewal engine 202 may update the result of the payment attempt 212. If a terminal error code was returned by the payment processor 210, then it may update the record to indicate that the payment method is not to be used in future transactions, as addressed further below. This update will help prevent reuse of a payment method that has been determined to fail (or at least be unlikely to succeed). The renewal engine 202 may communicate with the accounts database 206 to update the record. The renewal engine 202 may also communicate with an analytics group 214 to monitor the results and evaluate how the approach is performing.

The renewal engine 202 may update the account, which includes updating extended attributes data associated with the account. In some forms, updating the record (including updating the flag or key) may include storing a terminal error code received from the payment processor 210 and storing a timestamp indicating a time of receipt. In one form, this update may be stored in a database with a hash map data structure that uses a hash table for storing key-value pairs. Each key-value pair may include the terminal error code received from the payment processor and the corresponding timestamp. In some forms, the retry error codes may also be stored, such as, for example, as key-value pairs in a hash map data structure.

If a retry error code was returned by the payment processor 210, then the renewal engine 202 may make another payment attempt. It may transmit a second communication including a second electronic payment attempt to the payment processor 210 via the communication network 114. The timing of this second communication may depend on the specific retry error code that was returned, as addressed further below. In the context of a renewal, if the retried payment attempt is successful without receiving another error code from the payment processor 210, then the renewal engine 202 may renew the membership subscription associated with the record. Further, the renewal engine 202 may update the result of the payment attempt 212 at the account database 206 and/or the analytics group 214.

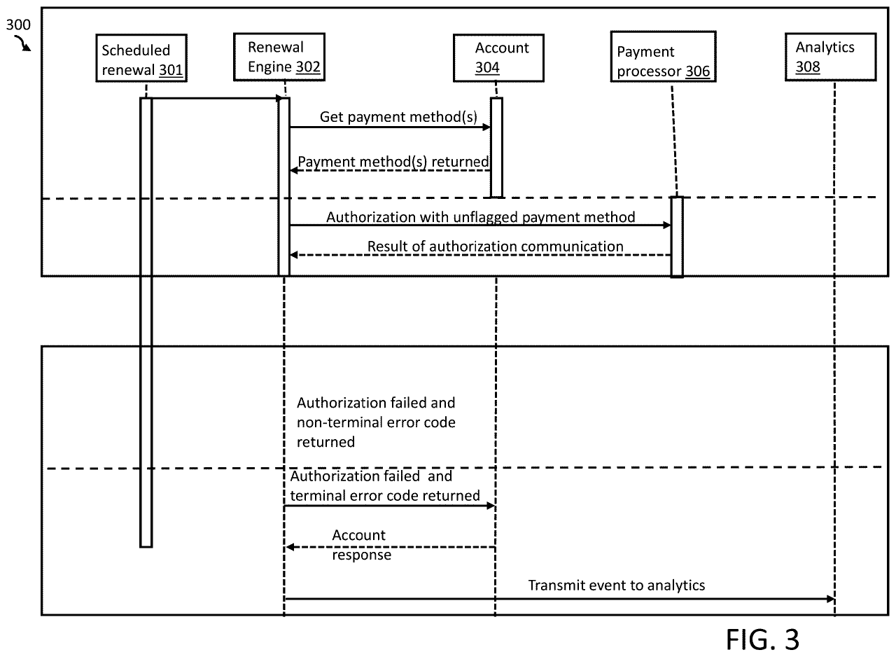

FIG. 3 depicts a sequence diagram showing another system 300 using error codes in the context of a membership renewal. In this form, when a scheduled renewal 301 arrives, a renewal engine 302 generally checks payment methods corresponding to the membership being renewed. It is generally contemplated that the renewal engine 302 may include some or all of the components from FIG. 1, including processing resource 102, and the components and steps addressed in FIG. 2. As stated above, although certain embodiments are described in the context of renewals, this disclosure is not limited to renewals and may be used in other circumstances where payment methods are being checked or are being used.

In FIG. 3, the renewal engine 302 (via processing resource 102) retrieves one or more payment methods from an account 304. The renewal engine 302 via processing resource 102 then checks a payment method to be tested to see if it has been flagged for non-use in some manner, such as, for example, by checking for terminal error codes in a database from past testing/previous renewal check. In one form, the renewal engine 302 via processing resource 102 may access a record or associated data, determine that the record or associated data includes a terminal error code from a previous unsuccessful payment attempt indicating a payment method is not to be used; retrieve a second payment method from the record; and format an electronic payment attempt to include the second payment method and transmit a communication including the electronic payment attempt to the payment processor 306 via the communication network 114. The renewal engine 302 via processing resource 102 proceeds with an authorization communication that includes the unflagged payment method to the payment processor 306. The payment processor 306 then transmits a responsive communication, which may either indicate success (with no error codes) or a declined payment (with error codes).

The renewal engine 302 via processing resource 102 matches the returned error code against a first set of known error codes (terminal error codes) and a second set of known error codes (retry error codes). As stated, it has been found that certain declined payment methods have been declined due to fraud-related error or other terminal error codes (which may include, for example, error codes A411, A433, A412, A417, A301, Z586). If the returned error code matches one of these known terminal error codes, this data is communicated to the account and/or any associated databases. It may also be transmitted to an analytics group 308 for evaluation of skipped payment methods, the overall success rate of payment methods, and/or declined payment trends.

The renewal engine 302 via processing resource 102 also checks the returned error code in instances where the authorization failed and an error code different than the terminal error codes was returned. The returned error code may match one of the known retry error codes, which may be treated in different ways. For example, one type of retry error code may involve retyring after a certain time period. In one form, there may be first subset of retry error code(s) indicating a potentially transient issue, and the processing resource 102 may transmit a second communication to the payment processor within a predetermined time period following the first communication. Another type of retry error code may involve retrying on a certain day of the week. In one form, there may be a second subset of retry error code(s) indicating the first electronic payment attempt was rejected for insufficient funds, and the processing resource 102 may transmit the second communication to the payment processor on a predetermined day of the week.

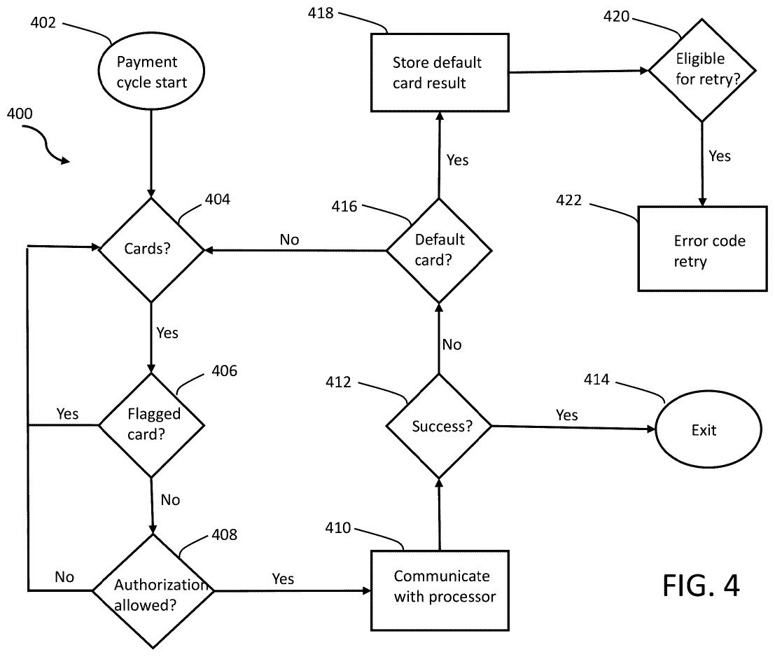

FIGS. 4-8 are flow diagrams depicting various example methods. In some forms, one or more blocks of the method may be performed at about the same time or in a different order than illustrated in the figures. In some forms, the method may not include all of the blocks/steps shown, may include additional blocks/steps, and/or some blocks/steps may be combined. In some forms, some of the blocks/steps may be repeated. It is generally contemplated that the method may be implemented in conjunction with executable instructions stored on a machine readable medium and a processing resource. Additionally, some aspects of the method may incorporate or be performed by one or more of the components shown in FIGS. 1-3, such as the processing resource 102.

FIG. 4 shows a flow diagram of a process 400 that may be used when checking payment methods. At block 402, the payment cycle starts, and in some examples, the check of payment methods is tied to the start of a payment cycle, such as, for example, a renewal of a membership. At block 404, the process 400 checks for any cards or other payment methods, such as, for example, those that may be stored in an online wallet. At block 406, the process 400 checks to see if the card or other payment method has been flagged, such as based on a previous check. If it has been flagged, the process 400 may return to block 404 to see if there are any other cards stored or available to be checked. At block 408, the process 400 determines if authorization is allowed. There may be circumstances under which authorization is not allowed, such as, for example, for certain types of payment methods or for certain categories of accounts. If not authorized, the process 400 may return to block 404 to see if other cards are stored or available to be checked.

At block 410, if authorization is allowed, the process 400 transmits an authorization to attempt payment using the payment method to the payment processor. At block 412, if the process 400 determines that the payment attempt was successful, then the process 400 exits at 414 and is completed. At block 416, if the payment attempt was not successful at block 412, the process 400 checks to see if the card used is a default card. If not the default card, the process 400 may return to block 404 for any additional payment method(s). At block 418, if the payment attempt was not successful and the card was the default card, the process 400 may store the result and update the status of the default card.

At block 420, if the payment attempt was not successful at block 412, the process 400 will determine eligibility for error code retry. There may be circumstances of ineligibility, such as, for example, the type of payment method or category of account involved. If not eligible for retry, the process 400 may return to block 404 for any additional payment methods. If eligible, the process 400 may execute a retry strategy at block 422 that may involve various retry approaches, as addressed below.

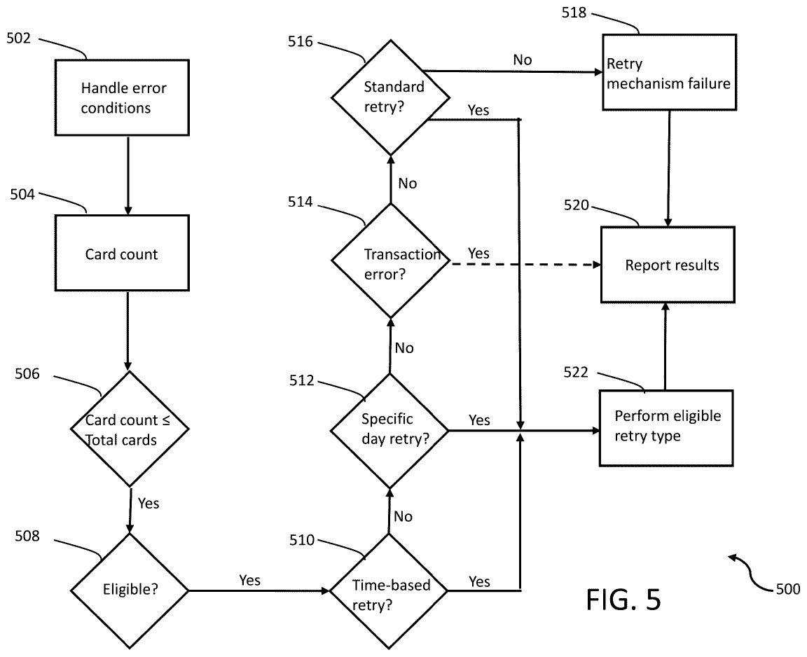

FIG. 5 is a flow diagram showing an example of a process 500 that may involve several different retry approaches. This retry mechanism may be applied at various stages of the overall process of checking payment methods. For example, it may be applied after a payment processor returns an error code for a specific payment method. Alternatively, it might be applied as more of a last resort after all of the payment methods have already been transmitted to the payment processor. Also, it should be understood that various retry approaches may be tried alone or in combination with other ones and may depend on the error codes that were returned.

In FIG. 5, at block 502, it may be determined that error codes have been returned and that the error conditions will be handled under some retry strategy. At block 504, the process 500 may keep a running card or other payment method count to cycle through the different stored or available cards or payment methods. At block 506, the process 500 may compare the running card or other payment method count to the total number of cards or payment methods. At block 508, there may be some initial determination of eligibility for retry, such as, for example, the type of payment method or category of account.

The process 500 then proceeds to specific retry mechanisms. In one form, in the context of renewals, when a payment method fails, instead of immediately canceling a membership, the process 500 may employ several retry mechanisms to process the payment method again. For example, as shown in FIG. 5, the following retry strategies may be applied: time-based retry, day-based retry, and standard retry.

At block 510, the process 500 may initially check the returned error code to determine if it is eligible for time-based retry. This retry mechanism may be applied when the issue is likely to be temporary and may resolve quickly. For instance, if the payment processor 306 returns the error code Z499, it has been learned that this error code indicates a potentially transient issue. The processing resource 102 may automatically schedule a retry after 24 hours (or some other determined time period). After this period, the payment method is reattempted for authorization and capture. This approach ensures that any short-term issues (e.g., network downtime or temporary fund holds) have a chance to be resolved before the next attempt. If eligible, then the process 500 may perform this eligible retry type at block 522.

Next, at block 512, the process 500 may check the returned error code to determine if it is eligible for day-based retry. This approach involves retrying the payment on a specific day of the week, often when the likelihood of success is deemed to be higher. For instance, if the payment fails due to insufficient funds (learned to be A410, A444, or Z503 error codes), the processing resource 102 may schedule a retry on a specific day of the week. If eligible, then the process 500 may perform this eligible retry type at block 522. Next, at block 514, if the card or other payment method was not eligible for either time-based entry or day-based retry, the process 500 may check to determine if any transaction resulted in a certain type of error. If there was a transaction error, this result may be reported at block 520.

At block 516, if there was no transaction error, the process 500 may proceed to standard retry. Regarding standard retry, this approach may be a catch-all approach that applies to a broader set of error codes, such that the system does not give up prematurely. In cases where error codes such as Z499, A410, A444, or Z503 are not returned, e.g., error codes other than those triggering time-based or day-based retry, a standard retry may be triggered, for example, three days after the initial failure. Alternatively, this approach may be used instead of time-based or day-based retry from some or all of the above error codes. This time period for standard retry may be selected to be longer than time-based retry, which may be known to involve error codes indicating a short term issue. In contrast, standard retry may provide a longer time period for potential long term issues to be resolved, like temporary payment system disruptions. If eligible, then the process 500 may perform this eligible retry type at block 522.

At block 518, if the card or other payment method is not eligible for any of the retry mechanisms or if one or more of the executed retry approaches were unsuccessful, the process 500 may determine that the retry mechanism was unsuccessful. At block 520, this retry mechanism failure may be reported. Further, if the card or other payment method was eligible for a retry mechanism and retry was performed at block 522, then the results of the retry may be reported at block 520. The process 500 may be repeated for additional cards or payment methods.

As stated, when applying the retry mechanism, there is flexibility to configure how and when different retries are applied. One such configurable option allows for the standard retry to be applied first, followed by either time-based or day-based retries. For example, standard retry may be tried twice, once initially before time-based retry at block 510 and then again as a last resort at block 516. This sequence ensures that broader, less time-sensitive error codes are addressed initially, while more targeted retry strategies are employed afterward, adapting to the nature of the failure. Furthermore, the frequency of retries can be customized based on other factors that may relate to the account or to the member.

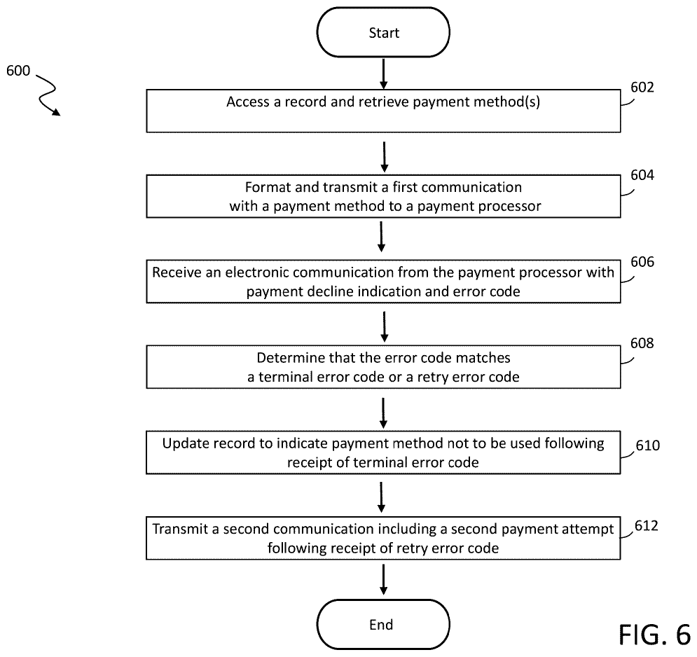

FIG. 6 shows a flow diagram of a process 600 that uses error codes received from a payment processor in connection with unsuccessful payment attempts. At block 602, a record may be accessed, and payment method(s) may be retrieved. In one form, the record may be part of a member account, and the accessing and retrieval may occur as part of a periodic membership renewal process. The payment methods may be bank accounts, credit cards, debit cards, etc.

At block 604, a first communication is formatted and transmitted with a payment method to a payment processor. In one form, the payment method may be successfully processed by the payment processor and no error codes returned. Alternatively, at block 606, an electronic communication is received from the payment processor with a declined payment indication and error code(s).

At block 608, it is determined that the error code(s) match a terminal error code or a retry error code. In one form, it is generally contemplated that two sets of known error codes (terminal error codes and retry error codes) that have been learned based on past transactions and stored. The terminal error codes generally indicate that a payment method will never (or is unlikely to be) successfully processed in the future. In contrast, retry error codes indicate that the declined payment may be a temporary circumstance and that the payment method may be successfully processed in the future.

At block 610, following receipt of a terminal error code, the record is updated to indicate that the payment method is not to be used in future transactions. At block 612, following receipt of a retry error code, a second communication is transmitted including a second payment attempt involving the same payment method. In one form, after transmitting the second payment attempt, the payment method may be successfully processed by the payment processor. Further, in the context of membership renewal, this successful processing may be used to renew a membership.

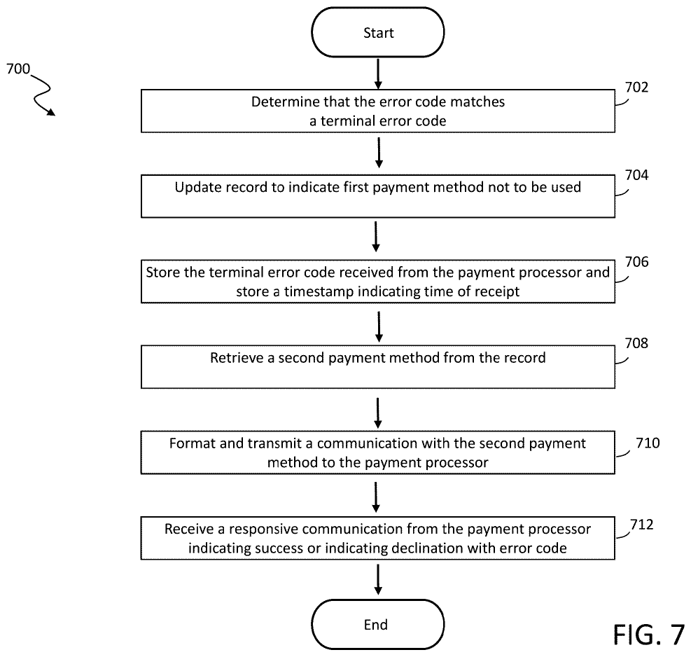

FIG. 7 shows a flow diagram of a process 700 that shows handling of terminal error codes. At block 702, it is determined that an error code returned from a payment processor matches a terminal error code. At block 704, a record is updated to indicate that the first payment method that was transmitted and declined by the payment processor is not to be used.

At block 706, the terminal error code received from the payment processor is stored and a timestamp indicating time of receipt is stored. In one form, the received terminal error code may be stored in database(s) having a hash map data structure. The hash map data structure may be in the form of a hash table for storing key-value pairs with each key-value pair including the terminal error code received from the payment processor and the timestamp. This hash map data structure may be searched when checking payment methods in future transactions to determine if a payment method was previously flagged for non-use.

At block 708, a second payment method is retrieved from the record. At block 710, a communication with the second payment method to the payment processor is formatted and transmitted. At block 712, a responsive communication from the payment processor is received indicating success or indicating a declined payment attempt with error code(s). If a declined payment attempt with a terminal error code is returned, a third payment method may be retrieved and transmitted to the payment processor. The process 700 may continue in this manner until no terminal error codes are returned or until there are no further payment methods to retrieve.

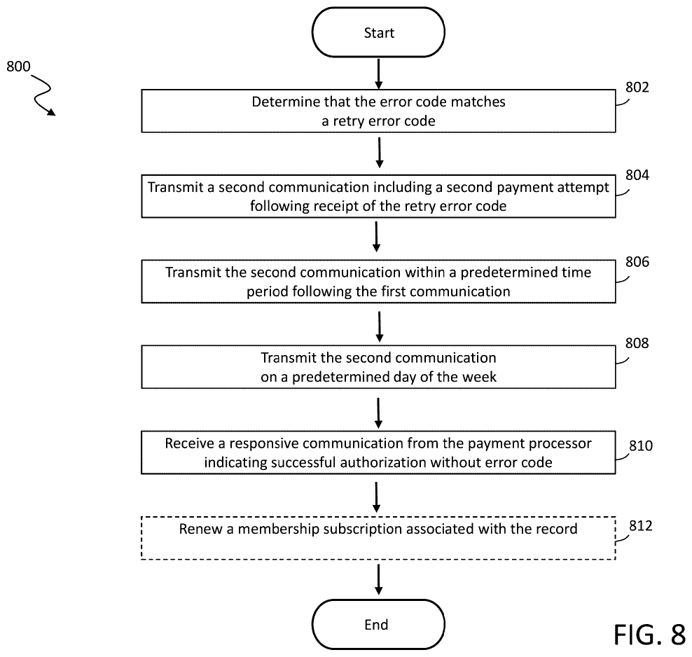

FIG. 8 shows a flow diagram of a process 800 that shows handling of retry error codes. At block 802, it is determined that an error code returned from a payment processor matches a retry error code. It is generally contemplated that the error code is returned from a payment processor in response to a payment method. Further, it is contemplated that the returned code may be matched against known error codes that have been learned based on past transactions and stored.

At block 804, following receipt of the matching error code, a second communication is transmitted including a second payment attempt involving the same payment method. It is contemplated that one of various retry approaches may be used, such as, for example, time-based retry, day-based retry, and standard retry, as were described above. At block 806, the second communication may be transmitted within a predetermined time period following the first communication (time-based retry or standard retry). At block 808, the second communication is transmitted on a predetermined day of the week (day-based retry).

A specific retry approach may depend on the specific retry code that was received from the payment processor. For example, one type of retry error code may indicate a potentially transient issue (which may support time-based retry), while another type of error code may indicate a declination based on certain timing and funding issues (which may support day-based retry). These retry approaches may also be tried in various sequences and combinations.

At block 810, in response to a retry approach, a responsive communication may be received from the payment processor indicating successful authorization without return of an error code. Optionally, at block 812, a membership subscription associated with the record is renewed. This process 800 may also be used in other contexts besides membership renewal.

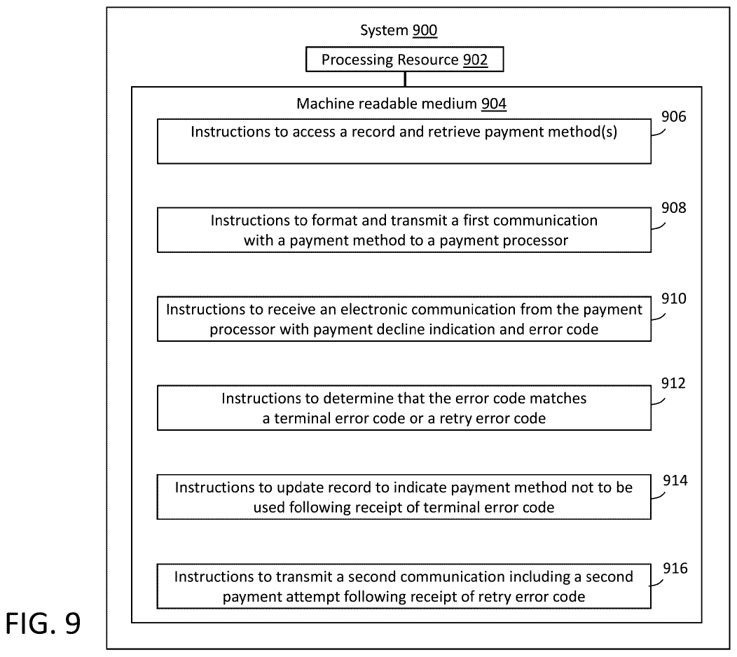

FIGS. 9-11 depict example systems 900, 1000, and 1100, respectively, that include non-transitory, machine readable media 904, 1004 and 1104, respectively, encoded with example instructions executable by processing resources 902, 1002, and 1002, respectively. In some forms, the systems 900, 1000, and 1100 may be useful for implementing aspects of the systems 100, 200, and 300 of FIGS. 1-3 or for performing aspects of methods 400, 500, 600, 700, and/or 800 of FIGS. 4-8, respectively. For example, the instructions encoded on machine readable media 904, 1004 and 1104 may be included in instructions 105 of FIG. 1. The processing resources 902, 1002, and 1102 may include a microcontroller, a microprocessor, central processing unit core(s), an ASIC, an FPGA, and/or other hardware device suitable for retrieval and/or execution of instructions from the machine readable media 904, 1004, and 1104 to perform functions related to various examples. Additionally or alternatively, the processing resources 902, 1002, and 1102 may include or be coupled to electronic circuitry or dedicated logic for performing some or all of the functionality of the instructions described herein.

The machine readable media 904, 1004, and 1104 may be any medium suitable for storing executable instructions, such as RAM, ROM, EEPROM, flash memory, a hard disk drive, an optical disc, or the like. In some examples, the machine readable media 904, 1004, and 1104 may be a tangible, non-transitory medium. The machine readable media 904, 1004, and 1104 may be disposed within the systems 900, 1000, and 1100 respectively, in which case the executable instructions may be deemed installed or embedded on the system. Alternatively, the machine readable media 904, 1004, and 1104 may be a portable (e.g., external) storage medium.

As described further herein below, the machine readable media 904, 1004, and 1104 may be encoded with a set of executable instructions. It should be understood that part or all of the executable instructions and/or electronic circuits included within one box may, in alternate forms, be included in a different box shown in the figures or in a different box not shown. Some implementations may include more or fewer instructions than are shown in FIGS. 9, 10, and 11

In FIG. 9, instructions may make use of error codes received from a payment processor in connection with unsuccessful payment attempts. Instructions 906, when executed, cause the processing resource 902 to access a record and retrieve payment method(s). The payment methods may include, for example, bank accounts, credit cards, debit cards, etc. Instructions 908, when executed, cause the processing resource 902 to format and transmit a first communication with a payment method to a payment processor. Instructions 910, when executed, cause the processing resource 902 to receive an electronic communication from the payment processor with a declined payment indication and error code(s).

Instructions 912, when executed, cause the processing resource 902 to determine that the error code(s) match a terminal error code or a retry error code. In one form, it is generally contemplated that two sets of known error codes (terminal error codes and retry error codes) that have been learned based on past transactions and stored. The terminal error codes generally indicate that a payment method will never (or is unlikely to be) successfully processed in the future. In contrast, retry error codes indicate that the declined payment may be a temporary circumstance and that the payment method may be successfully processed in the future. Instructions 914, when executed, cause the processing resource 902, following receipt of a terminal error code, to update the record to indicate that the payment method is not to be used in future transactions. Instructions 916, when executed, cause the processing resource 902, following receipt of a retry error code, to transmit a second communication including a second payment attempt involving the same payment method.

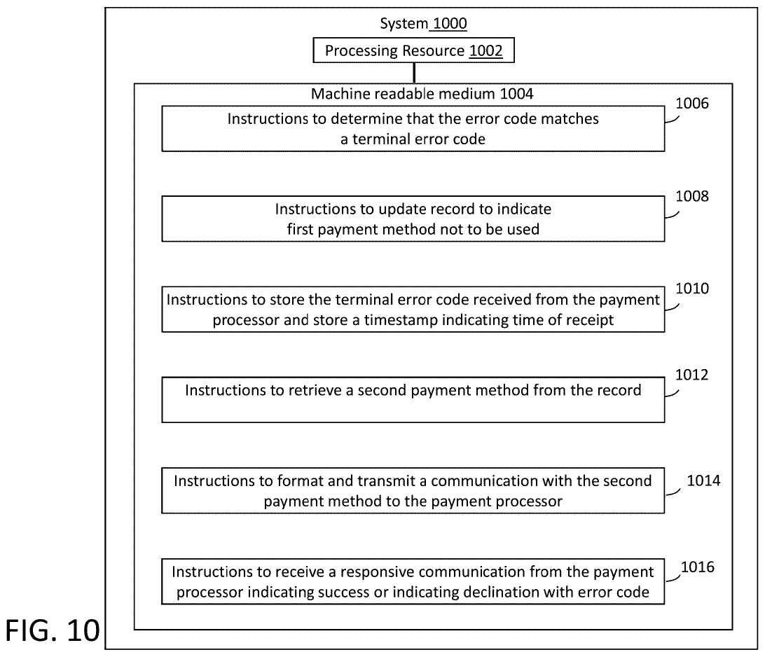

In FIG. 10, the instructions may be useful in the handling of terminal error codes. Instructions 1006, when executed, cause the processing resource 1002 to determine that an error code returned from a payment processor matches a terminal error code. Instructions 1008, when executed, cause the processing resource 1002 to update a record to indicate that the first payment method that was transmitted and declined by the payment processor is not to be used. Instructions 1010, when executed, cause the processing resource 1002 to store the terminal error code received from the payment processor and a timestamp indicating time of receipt.

Instructions 1012, when executed, cause the processing resource 1002 to retrieve a second payment method from the record. Instructions 1014, when executed, cause the processing resource 1002 to format and transmit a communication with the second payment method to the payment processor. Instructions 1016, when executed, cause the processing resource 1002 to receive a responsive communication from the payment processor indicating success or indicating a declined payment attempt with error code(s).

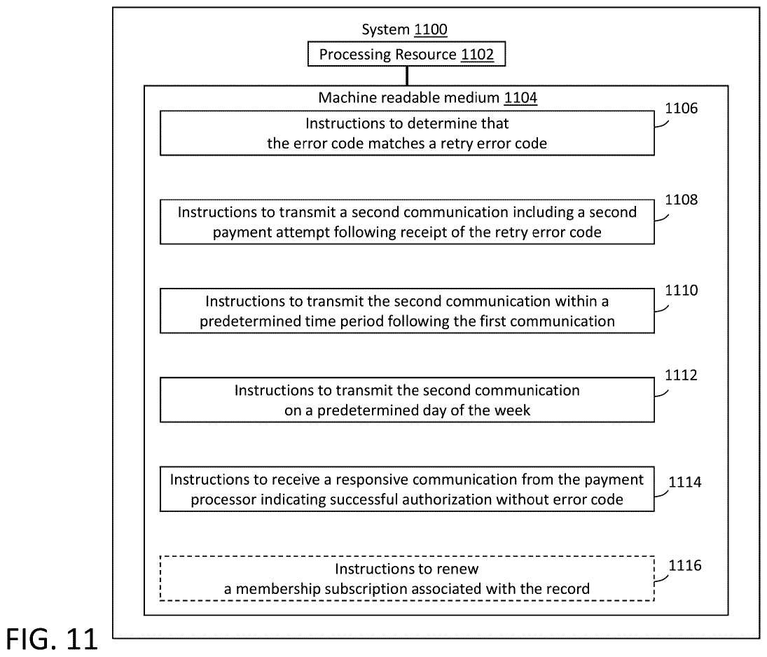

In FIG. 11, the instructions may be useful in the handling of retry error codes. Instructions 1106, when executed, cause the processing resource 1102 to determine that an error code returned from a payment processor matches a retry error code. It is generally contemplated that the error code is returned from a payment processor in response to a payment method. Further, it is contemplated that the returned code may be matched against known error codes that have been learned based on past transactions and stored.

Instructions 1108, when executed, cause the processing resource 1102, following receipt of the matching error code, to transmit a second communication including a second payment attempt involving the same payment method. Instructions 1110, when executed, cause the processing resource 1102 to transmit the second communication within a predetermined time period following the first communication (time-based retry or standard retry). Instructions 1112, when executed, cause the processing resource 1102 to transmit the second communication on a predetermined day of the week (day-based retry). In one form, it is contemplated that instructions 1110 and 1112 may be performed alternatively under differing circumstances. Instructions 1114, when executed, cause the processing resource 1102, in response to a retry approach, receive a responsive communication from the payment processor indicating successful authorization without return of an error code. Optionally, Instructions 1116, when executed, cause the processing resource 1102 to renew a membership subscription associated with the record is renewed. The system 1100 may also be used in other contexts besides membership renewal.

As stated earlier, although this disclosure generally refers to payments, payment methods, payment attempts, payment processors, etc., it should be understood that these terms can more generically be referred to in acquisition completion terms, e.g., where an item or service is intended to be acquired and this acquisition is to be completed. This disclosure is broadly directed to any of various types of transactions that involve some form of acquisition completion. For example, in some embodiments, one or more of: a payment may be more generically referred to as an acquisition completion; a payment method may be more generically referred to as an acquisition completion method; a payment attempt may be more generically referred to as an acquisition completion attempt; a payment processor may be more generically referred to as an acquisition completion processor; a payment decline indication may be more generically referred to as an acquisition completion decline indication; and a payment authorization indication may be more generically referred to as an acquisition completion authorization indication.

Generally speaking, pursuant to various embodiments, systems, apparatuses, and methods are provided herein useful to communications with transaction processors. In one form, the system includes: one or more databases including a plurality of records, each record corresponding to a user and including one or more acquisition completion methods; a communication transceiver to communicate via a communication network; a processing resource coupled to the one or more databases and the communication transceiver; and a machine readable medium storing instructions. The instructions, when executed by the processing resource, cause the processing resource to: access a record of the one or more databases; retrieve an acquisition completion method from the record; format a first electronic acquisition completion attempt to include the acquisition completion method and transmit, using the communication transceiver, a first communication including the first electronic acquisition completion attempt to an acquisition completion processor via a communication network; receive an electronic communication from the acquisition completion processor via the communication network and the communication transceiver, the electronic communication comprising an acquisition completion decline indication and including an error code; determine that the error code matches one of a predetermined first set of one or more error codes, the predetermined first set of one or more error codes learned to be terminal error codes such that subsequent acquisition completion attempts will fail, or matches one of a predetermined second set of one or more error codes, the predetermined second set of one or more error codes learned to be retry error codes such that subsequent acquisition completion attempts may be successful under one or more circumstances, the one or more circumstances specific to each retry error code; update the record to indicate that the acquisition completion method is not to be used in future transactions following a determination that the error code received from the acquisition completion processor is one of the terminal error codes; and transmit, using the communication transceiver, a second communication including a second electronic acquisition completion attempt to the acquisition completion processor via the communication network following a determination that the error code received from the acquisition completion processor is one of the retry error codes.

In some implementations, in the system, updating the record to indicate that the acquisition completion method is not to be used in future transactions includes storing a terminal error code received from the acquisition completion processor and storing a timestamp indicating time of receipt. In some implementations, the one or more databases include a hash map data structure, the hash map data structure using a hash table for storing key-value pairs, each key-value pair including the terminal error code received from the acquisition completion processor and the timestamp. In some implementations, the predetermined second set of one or more error codes includes a predetermined first subset of one or more error codes indicating a potentially transient issue; and the instructions, when executed, cause the processing resource to: transmit the second communication to the acquisition completion processor within a predetermined time period following the first communication. In some implementations, the predetermined second set of one or more error codes comprises a predetermined second subset of one or more error codes indicating the first electronic acquisition completion attempt was rejected for insufficient funds; and the instructions, when executed, cause the processing resource to: transmit the second communication to the acquisition completion processor on a predetermined day of the week. In some implementations, the instructions, when executed, cause the processing resource to: renew a membership subscription associated with the record upon successful transmission of the second communication without receiving an error code from the acquisition completion processor. In some implementations, the instructions, when executed, cause the processing resource to: access the record or associated data; determine that the record or associated data includes a terminal error code from a previous unsuccessful acquisition completion attempt indicating a first acquisition completion method is not to be used; retrieve a second acquisition completion method from the record; and format an electronic acquisition completion attempt to include the second acquisition completion method and transmit a communication including the electronic acquisition completion attempt to the acquisition completion processor via the communication network. In some implementations, the instructions, when executed, cause the processing resource to: transmit the first communication on a day when a membership subscription utilizing the acquisition completion method is considered for renewal.

In another form, there is provided a method including: accessing a record of one or more databases including a plurality of records, each record corresponding to a customer and including one or more acquisition completion methods; retrieving an acquisition completion method from the record; formatting a first electronic acquisition completion attempt to include the acquisition completion method and transmitting, using a communication transceiver to communicate via a communication network, a first communication including the first electronic acquisition completion attempt to an acquisition completion processor; receiving an electronic communication from the acquisition completion processor via the communication network and the communication transceiver, the electronic communication comprising an acquisition completion decline indication and including an error code; determining that the error code matches one of a predetermined first set of one or more error codes, the predetermined first set of one or more error codes learned to be terminal error codes such that subsequent acquisition completion attempts will fail, or matches one of a predetermined second set of one or more error codes, the predetermined second set of one or more error codes learned to be retry error codes such that subsequent acquisition completion attempts may be successful under one or more circumstances, the one or more circumstances specific to each retry error code; updating the record to indicate that the acquisition completion method is not to be used in future transactions following a determination that the error code received from the acquisition completion processor is one of the terminal error codes; and transmitting, using the communication transceiver, a second communication including a second electronic acquisition completion attempt to the acquisition completion processor via the communication network following a determination that the error code received from the acquisition completion processor is one of the retry error codes.

In some implementations, updating the record to indicate that the acquisition completion method is not to be used in future transactions comprises storing a terminal error code received from the acquisition completion processor and storing a timestamp indicating time of receipt. In some implementations, the predetermined second set of one or more error codes comprises a predetermined first subset of one or more error codes indicating a potentially transient issue, the method further including: transmitting the second communication to the acquisition completion processor within a predetermined time period following the first communication. In some implementations, the predetermined second set of one or more error codes comprises a predetermined second subset of one or more error codes indicating the first electronic acquisition completion attempt was rejected for insufficient funds, the method further including: transmitting the second communication to the acquisition completion processor on a predetermined day of the week. In some implementations, the method further includes: renewing a membership subscription associated with the record upon successful transmission of the second communication without receiving an error code from the acquisition completion processor. In some implementations, the method further includes: accessing the record or associated data; determining that the record or associated data includes a terminal error code from a previous unsuccessful acquisition completion attempt indicating a first acquisition completion method is not to be used; retrieving a second acquisition completion method from the record; and
formatting an electronic acquisition completion attempt to include the second acquisition completion method and transmitting a communication including the electronic acquisition completion attempt to the acquisition completion processor via the communication network. In some implementations, the method further includes: transmitting the first communication on a day when a membership subscription utilizing the acquisition completion method is considered for renewal.

In another form, there is provided a non-transitory machine readable medium storing instructions that, when executed, cause a processing resource to: access a record of one or more databases including a plurality of records, each record corresponding to a customer and including one or more acquisition completion methods; retrieve an acquisition completion method from the record; format a first electronic acquisition completion attempt to include the acquisition completion method and transmit, using a communication transceiver to communicate via a communication network, a first communication including the first electronic acquisition completion attempt to an acquisition completion processor; receive an electronic communication from the acquisition completion processor via the communication network and the communication transceiver, the electronic communication comprising an acquisition completion decline indication and including an error code; determine that the error code matches one of a predetermined first set of one or more error codes, the predetermined first set of one or more error codes learned to be terminal error codes such that subsequent acquisition completion attempts will fail, or matches one of a predetermined second set of one or more error codes, the predetermined second set of one or more error codes learned to be retry error codes such that subsequent acquisition completion attempts may be successful under one or more circumstances, the one or more circumstances specific to each retry error code; update the record to indicate that the acquisition completion method is not to be used in future transactions following a determination that the error code received from the acquisition completion processor is one of the terminal error codes; and transmit, using the communication transceiver, a second communication including a second electronic acquisition completion attempt to the acquisition completion processor via the communication network following a determination that the error code received from the acquisition completion processor is one of the retry error codes.

In some implementations, updating the record to indicate that the acquisition completion method is not to be used in future transactions comprises storing a terminal error code received from the acquisition completion processor and storing a timestamp indicating time of receipt. In some implementations, the predetermined second set of one or more error codes comprises a predetermined first subset of one or more error codes indicating a potentially transient issue; and the instructions, when executed, cause the processing resource to transmit the second communication to the acquisition completion processor within a predetermined time period following the first communication. In some implementations, the predetermined second set of one or more error codes comprises a predetermined second subset of one or more error codes indicating the first electronic acquisition completion attempt was rejected for insufficient funds; and the instructions, when executed, cause the processing resource to transmit the second communication to the acquisition completion processor on a predetermined day of the week. In some implementations, the instructions, when executed, cause the processing resource to renew a membership subscription associated with the record upon successful transmission of the second communication without receiving an error code from the acquisition completion processor.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
one or more databases including a plurality of records, each record corresponding to a user and including one or more acquisition completion methods;
a communication transceiver to communicate via a communication network;
a processing resource coupled to the one or more databases and the communication transceiver; and
a machine readable medium storing instructions that, when executed by the processing resource, cause the processing resource to:
access a record of the one or more databases;
retrieve an acquisition completion method from the record;
format a first electronic acquisition completion attempt to include the acquisition completion method and transmit, using the communication transceiver, a first communication including the first electronic acquisition completion attempt to an acquisition completion processor via the communication network;
receive an electronic communication from the acquisition completion processor via the communication network and the communication transceiver, the electronic communication comprising an acquisition completion decline indication and including an error code;
determine that the error code matches one of a predetermined first set of one or more error codes, the predetermined first set of one or more error codes learned to be terminal error codes such that subsequent acquisition completion attempts will fail, or matches one of a predetermined second set of one or more error codes, the predetermined second set of one or more error codes learned to be retry error codes such that subsequent acquisition completion attempts may be successful under one or more circumstances, the one or more circumstances specific to each retry error code;
update the record to indicate that the acquisition completion method is not to be used in future transactions following a determination that the error code received from the acquisition completion processor is one of the terminal error codes; and
transmit, using the communication transceiver, a second communication including a second electronic acquisition completion attempt to the acquisition completion processor via the communication network following a determination that the error code received from the acquisition completion processor is one of the retry error codes.

2. The system of claim 1, wherein:
updating the record to indicate that the acquisition completion method is not to be used in future transactions comprises storing a terminal error code received from the acquisition completion processor and storing a timestamp indicating time of receipt.

3. The system of claim 2, wherein the one or more databases comprises a hash map data structure, the hash map data structure using a hash table for storing key-value pairs, each key-value pair including the terminal error code received from the acquisition completion processor and the timestamp.

4. The system of claim 1,
wherein the predetermined second set of one or more error codes comprises a predetermined first subset of one or more error codes indicating a potentially transient issue;
wherein the instructions, when executed, cause the processing resource to: transmit the second communication to the acquisition completion processor within a predetermined time period following the first communication.

5. The system of claim 1,
wherein the predetermined second set of one or more error codes comprises a predetermined second subset of one or more error codes indicating the first electronic acquisition completion attempt was rejected for insufficient funds;
wherein the instructions, when executed, cause the processing resource to: transmit the second communication to the acquisition completion processor on a predetermined day of the week.

6. The system of claim 1, wherein the instructions, when executed, cause the processing resource to:
renew a membership subscription associated with the record upon successful transmission of the second communication without receiving an error code from the acquisition completion processor.

7. The system of claim 1, wherein the instructions, when executed, cause the processing resource to:
access the record or associated data;
determine that the record or associated data includes a terminal error code from a previous unsuccessful acquisition completion attempt indicating a first acquisition completion method is not to be used;
retrieve a second acquisition completion method from the record; and
format an electronic acquisition completion attempt to include the second acquisition completion method and transmit a communication including the electronic acquisition completion attempt to the acquisition completion processor via the communication network.

8. The system of claim 1, wherein the instructions, when executed, cause the processing resource to:
transmit the first communication on a day when a membership subscription utilizing the acquisition completion method is considered for renewal.

9. A method comprising:
accessing a record of one or more databases including a plurality of records, each record corresponding to a customer and including one or more acquisition completion methods;
retrieving an acquisition completion method from the record;
formatting a first electronic acquisition completion attempt to include the acquisition completion method and transmitting, using a communication transceiver to communicate via a communication network, a first communication including the first electronic acquisition completion attempt to an acquisition completion processor;
receiving an electronic communication from the acquisition completion processor via the communication network and the communication transceiver, the electronic communication comprising an acquisition completion decline indication and including an error code;
determining that the error code matches one of a predetermined first set of one or more error codes, the predetermined first set of one or more error codes learned to be terminal error codes such that subsequent acquisition completion attempts will fail, or matches one of a predetermined second set of one or more error codes, the predetermined second set of one or more error codes learned to be retry error codes such that subsequent acquisition completion attempts may be successful under one or more circumstances, the one or more circumstances specific to each retry error code;
updating the record to indicate that the acquisition completion method is not to be used in future transactions following a determination that the error code received from the acquisition completion processor is one of the terminal error codes; and
transmitting, using the communication transceiver, a second communication including a second electronic acquisition completion attempt to the acquisition completion processor via the communication network following a determination that the error code received from the acquisition completion processor is one of the retry error codes.

10. The method of claim 9, wherein:
updating the record to indicate that the acquisition completion method is not to be used in future transactions comprises storing a terminal error code received from the acquisition completion processor and storing a timestamp indicating time of receipt.

11. The method of claim 9, wherein the predetermined second set of one or more error codes comprises a predetermined first subset of one or more error codes indicating a potentially transient issue, the method further comprising:
transmitting the second communication to the acquisition completion processor within a predetermined time period following the first communication.

12. The method of claim 9, wherein the predetermined second set of one or more error codes comprises a predetermined second subset of one or more error codes indicating the first electronic acquisition completion attempt was rejected for insufficient funds, the method further comprising:
transmitting the second communication to the acquisition completion processor on a predetermined day of the week.

13. The method of claim 9, further comprising:
renewing a membership subscription associated with the record upon successful transmission of the second communication without receiving an error code from the acquisition completion processor.

14. The method of claim 9, further comprising:
accessing the record or associated data;
determining that the record or associated data includes a terminal error code from a previous unsuccessful acquisition completion attempt indicating a first acquisition completion method is not to be used;
retrieving a second acquisition completion method from the record; and
formatting an electronic acquisition completion attempt to include the second acquisition completion method and transmitting a communication including the electronic acquisition completion attempt to the acquisition completion processor via the communication network.

15. The method of claim 9, further comprising:
transmitting the first communication on a day when a membership subscription utilizing the acquisition completion method is considered for renewal.

16. A non-transitory machine readable medium storing instructions that, when executed, cause a processing resource to:
access a record of one or more databases including a plurality of records, each record corresponding to a customer and including one or more acquisition completion methods;
retrieve an acquisition completion method from the record;
format a first electronic acquisition completion attempt to include the acquisition completion method and transmit, using a communication transceiver to communication via a communication network, a first communication including the first electronic acquisition completion attempt to an acquisition completion processor;
receive an electronic communication from the acquisition completion processor via the communication network and the communication transceiver, the electronic communication comprising an acquisition completion decline indication and including an error code;
determine that the error code matches one of a predetermined first set of one or more error codes, the predetermined first set of one or more error codes learned to be terminal error codes such that subsequent acquisition completion attempts will fail, or matches one of a predetermined second set of one or more error codes, the predetermined second set of one or more error codes learned to be retry error codes such that subsequent acquisition completion attempts may be successful under one or more circumstances, the one or more circumstances specific to each retry error code;
update the record to indicate that the acquisition completion method is not to be used in future transactions following a determination that the error code received from the acquisition completion processor is one of the terminal error codes; and
transmit, using the communication transceiver, a second communication including a second electronic acquisition completion attempt to the acquisition completion processor via the communication network following a determination that the error code received from the acquisition completion processor is one of the retry error codes.

17. The non-transitory machine readable medium of claim 16, wherein:
updating the record to indicate that the acquisition completion method is not to be used in future transactions comprises storing a terminal error code received from the acquisition completion processor and storing a timestamp indicating time of receipt.

18. The non-transitory machine readable medium of claim 16,
wherein the predetermined second set of one or more error codes comprises a predetermined first subset of one or more error codes indicating a potentially transient issue;
wherein the instructions, when executed, cause the processing resource to transmit the second communication to the acquisition completion processor within a predetermined time period following the first communication.

19. The non-transitory machine readable medium of claim 16,
wherein the predetermined second set of one or more error codes comprises a predetermined second subset of one or more error codes indicating the first electronic acquisition completion attempt was rejected for insufficient funds;
wherein the instructions, when executed, cause the processing resource to transmit the second communication to the acquisition completion processor on a predetermined day of the week.

20. The non-transitory machine readable medium of claim 16,
wherein the instructions, when executed, cause the processing resource to renew a membership subscription associated with the record upon successful transmission of the second communication without receiving an error code from the acquisition completion processor.
